(19) United States
(12) Patent Application Publication
(10) Pub. No.: US 2020/0013170 A1
(43) Pub. Date: Jan. 9, 2020

(54) INFORMATION PROCESSING APPARATUS, REBAR COUNTING APPARATUS, AND METHOD

(71) Applicants: Olympus Corporation, Tokyo (JP); Kajima Corporation, Tokyo (JP)

(72) Inventors: Kiiko TAKAMATSU, Tokyo (JP); Yukihito FURUHASHI, Tokyo (JP); Kunio YAMADA, Tokyo (JP); Yasuhiro KOMIYA, Sagamihara (JP); Naoki MORIMOTO, Tokyo (JP); Hirohisa HAYAKAWA, Tokyo (JP); Yohei TAIRA, Tokyo (JP); Toshikazu TANIGUCHI, Tokyo (JP)

(21) Appl. No.: 16/573,961

(22) Filed: Sep. 17, 2019

Related U.S. Application Data
(63) Continuation of application No. PCT/JP2018/013545, filed on Mar. 30, 2018.

(30) Foreign Application Priority Data
Mar. 31, 2017 (JP) 2017-069430
Mar. 31, 2017 (JP) 2017-069439

(51) Int. Cl. G06T 7/13

(52) U.S. Cl. CPC G06T 7/13

(57) ABSTRACT

An apparatus includes a memory and a processor connected to the memory, wherein the processor acquires a plurality of images of an installed rebar group that have been captured while an image capturing region is being moved in a direction intersecting the rebar group, detects a tracking target from a first edge portion, and correlates, when the processor has detected the tracking target from the first edge portion, either of a detection image that is an image of the detected tracking target or a captured image captured after the detection or alternative information generated on the basis of the detection image or the captured image with identification information for identifying a rebar belonging to the rebar group and located within a predetermined range from the tracking target, and records the image, or alternative information correlated with the identification information in a recording apparatus.

### CROSS REFERENCE TO RELATED APPLICATIONS

This application is based upon and claims the benefit of priority of the prior Japanese Patent Application No. 2017-069430, filed on Mar. 31, 2017, and the Japanese Patent Application No. 2017-069439, filed on Mar. 31, 2017, the entire contents of which are incorporated herein by reference.

This application is a continuation application of International Application PCT/JP2018/013545 filed on Mar. 30, 2018, the entire contents of which are incorporated herein by reference.

### BACKGROUND OF THE INVENTION

### Field of the Invention

The present invention pertains to a technique for measuring rebars that have been installed.

Construction of, for example, reinforced-concrete buildings has conventionally involved a bar arrangement inspection for checking whether rebars are disposed at correct positions on the basis of, for example, a bar arrangement drawing. The bar arrangement inspection may involve the process of counting the number of rebars to determine whether a correct number of rebars have been installed. In recent years, introduction of a system for assisting a bar arrangement inspection (hereinafter referred to as a “bar-arrangement-inspection assistance system”) has been considered for the purpose of improving the efficiency of the bar arrangement inspection or reducing the burden on the inspector performing the bar arrangement inspection.

Japanese Laid-open Patent Publication No. 2016-003981 indicates an example of the bar-arrangement-inspection assistance system.

### SUMMARY OF THE INVENTION

An information processing apparatus in accordance with an aspect includes a memory and a processor connected to the memory, wherein the processor acquires, in order of image capturing, a plurality of images of an installed rebar group that have been captured while an image capturing region is being moved in a direction intersecting the rebar group, detects a tracking target from a first edge portion that is an edge portion of an image acquired by the acquisition and is also an edge portion in a movement direction in which the rebar group is moved within the image, and correlates, when the processor has detected the tracking target from the first edge portion, either of a detection image that is an image of the detected tracking target or a captured image that is an image of the rebar group that has been newly captured after the detection of the tracking target or alternative information generated on the basis of the detection image or the captured image with identification information for identifying a rebar belonging to the rebar group and located within a predetermined range from the tracking target, and records the detection image, the captured image, or alternative information correlated with the identification information in a recording apparatus.

### BRIEF DESCRIPTION OF THE DRAWINGS

FIG. 1 exemplifies the configuration of a bar-arrangement-inspection assistance system in accordance with a first embodiment;

FIG. 2 is an explanatory diagram for a method of capturing an image of a subject;

FIG. 3 illustrates a direction in which a subject within an image moves;

FIG. 4 exemplifies the hardware configuration of an information processing apparatus in accordance with a first embodiment;

FIG. 5 exemplifies the functional configuration of an information processing apparatus in accordance with a first embodiment;

FIG. 6 exemplifies the functional configuration of a detection unit in accordance with a first embodiment;

FIG. 7 is a flowchart illustrating an example of information processing;

FIG. 8 is a flowchart illustrating an example of a detection process;

FIG. 9 is an explanatory diagram for a detection process depicted in FIG. 8;

FIG. 10 is a flowchart illustrating an example of a recording control process;

FIG. 11 exemplifies the functional configuration of a detection unit in accordance with a second embodiment;

FIG. 12 is a flowchart illustrating another example of a detection process;

FIG. 13 is an explanatory diagram for a detection process depicted in FIG. 12;

FIG. 14 exemplifies the functional configuration of an information processing apparatus in accordance with a third embodiment;

FIG. 15 is a flowchart illustrating still another example of a detection process;

FIG. 16 exemplifies the functional configuration of a detection unit in accordance with a fourth embodiment;

FIG. 17 is a flowchart illustrating yet another example of a detection process;

FIG. 18 exemplifies the functional configuration of an information processing apparatus in accordance with a fifth embodiment;

FIG. 19 exemplifies the configuration of a bar-arrangement-inspection assistance system in accordance with a sixth embodiment;

FIG. 20 exemplifies the functional configuration of an information processing apparatus in accordance with a sixth embodiment;

FIG. 21 exemplifies the configuration of a bar-arrangement-inspection assistance system in accordance with a seventh embodiment; and

FIG. 22 exemplifies the functional configuration of an information processing apparatus in accordance with a seventh embodiment.

### DESCRIPTION OF THE PREFERRED EMBODIMENTS

Japanese Laid-open Patent Publication No. 2016-003981 describes the feature wherein overlaps of rebars to be inspected and a background bar that includes markers at the two longitudinal edges thereof are extracted from an image that has been captured with the background bar installed behind the rebars to be inspected, and the number of the rebars to be inspected is calculated in accordance with the extracted overlaps.

Rebars may be assembled over a wide range in a building site, and in many cases, rebars to be inspected cannot be indicated in a single image. Hence, images of rebars need to be sequentially captured while moving within a region in which image capturing is performed. The invention of Japanese Laid-open Patent Publication No. 2016-003981 is such that when all of the rebars to be inspected cannot be located between the markers, images need to be captured while shifting the position of the background bar. In this case, the operator needs to count the number of rebars by means of captured images while being careful not to count the same rebars more than once.

When rebars to be inspected are disposed over a wide range as described above, the background bar will need to be repeatedly moved and installed, and rebars indicated in two or more captured images will need to be determined, thereby imposing a large burden on the operator.

In view of the actual situation described above, it will be desirable to provide a technique for reducing the burden on the operator in performing a bar arrangement inspection even when rebars are disposed over a wide range.

### First Embodiment

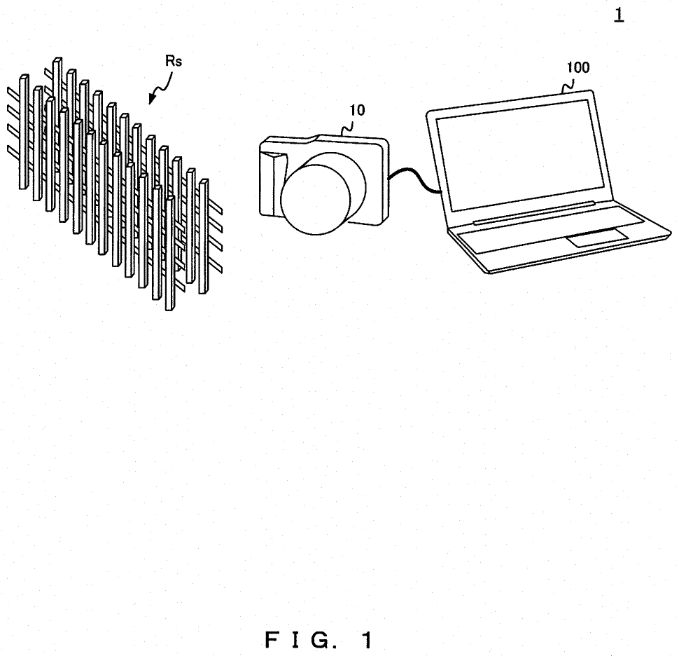

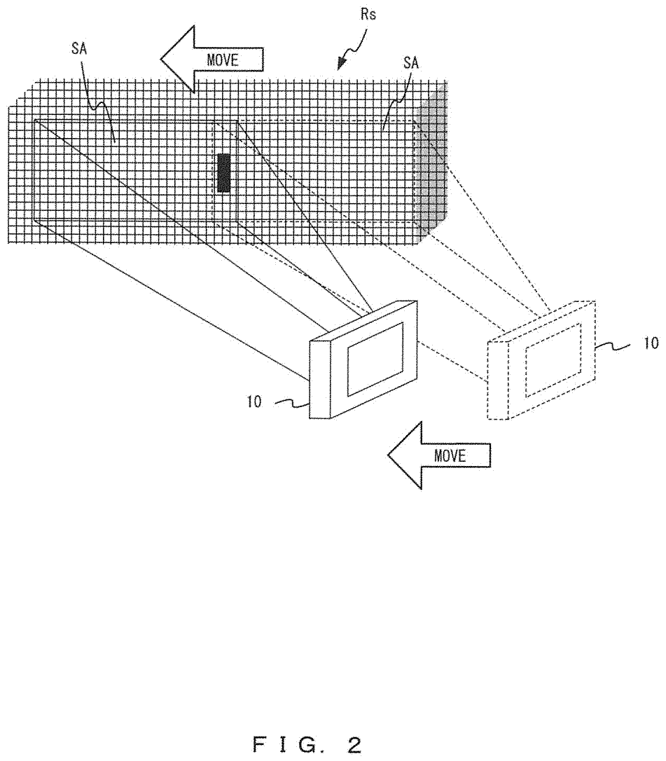

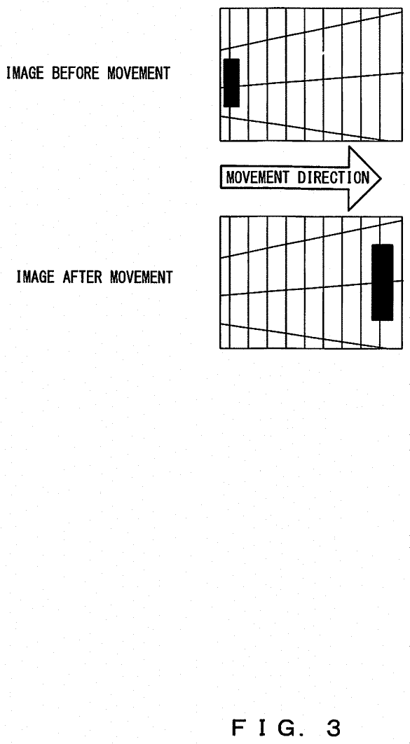

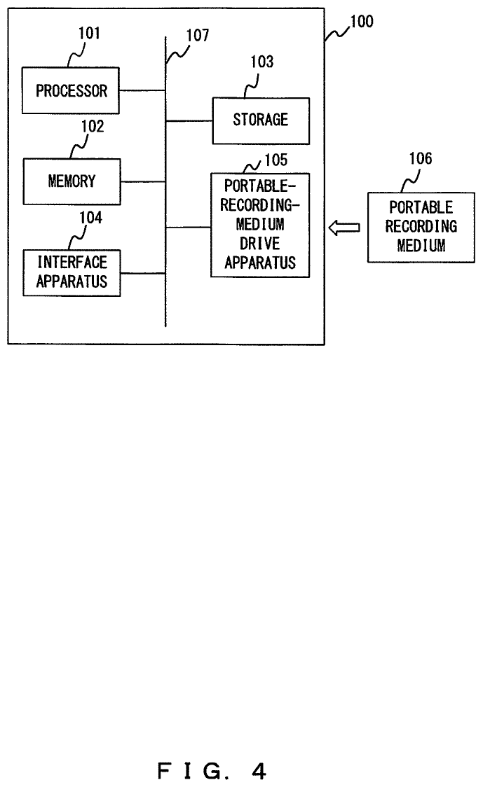

FIG. 1 exemplifies the configuration of a bar-arrangement-inspection assistance system 1. FIG. 2 is an explanatory diagram for a method of capturing an image of a subject Rs. FIG. 3 illustrates a direction in which a subject within an image moves. FIG. 4 exemplifies the hardware configuration of an information processing apparatus 100.

The bar-arrangement-inspection assistance system 1 inspects a rebar group that has been installed, i.e., a subject Rs, and inspects, for example, the arrangement and number of rebars. The bar-arrangement-inspection assistance system 1 includes a digital camera 10 and an information processing apparatus 100.

In the example of FIG. 1, the digital camera 10 and the information processing apparatus 100 are connected to each other by a cable. The digital camera 10 and the information processing apparatus 100 may be configured to exchange data therebetween and may be communicably connected to each other wirelessly, not only by a wired link. The digital camera 10 and the information processing apparatus 100 may exchange data therebetween via, for example, a portable recording medium such as a universal serial bus (USB) memory.

The digital camera 10 is an image capturing apparatus for capturing an image of a subject Rs. The digital camera 10 has a moving-image capturing function and will desirably further have a still-image capturing function. That is, the digital camera 10 is at least a digital video camera and will desirably further be a digital still camera.

The digital camera 10 captures, as depicted in FIG. 2, a moving image of a rebar group to be inspected, i.e., a subject Rs, while an image capturing region SA is being moved in a direction intersecting the subject Rs and outputs the moving image to the information processing apparatus 100. The image capturing region SA may be moved by changing the orientation of the digital camera 10 without moving the digital camera 10. As depicted in FIG. 3, the image capturing region SA moves in a direction (hereinafter referred to as a first direction) opposite from a direction in which the subject moves within the image (hereinafter referred to as a second direction). The second direction in which a subject moves within an image will also hereinafter simply be referred to as a movement direction or an image movement direction.

The information processing apparatus 100 is a recording control apparatus that records, in a recording apparatus, information to be used for rebar measurement in a bar arrangement inspection by processing a moving image (hereinafter referred to as rebar measurement information). The information recording apparatus 100 is, for example, a standard computer and includes, as depicted in FIG. 4, a processor 101, a memory 102, a storage 103, an interface apparatus 104, and a portable-recording-medium drive apparatus 105 into which a portable recording medium 106 is to be inserted, all of which are connected to each other by a bus 107.

The processor 101 is, for example, a central processing unit (CPU), a micro processing unit (MPU), or a digital signal processor (DSP) and executes programmed processing by running a program.

The memory 102 is, for example, a random access memory (RAM). In program execution, the memory 102 temporarily stores a program or data from the storage 103 or the portable recording medium 106. The storage 103, which is an example of the above-described recording apparatus, is, for example, a hard disk or a flash memory. The storage 103 is used to store, for example, various data and programs, including rebar measurement information.

The interface apparatus 104 is a circuit that exchanges data with apparatuses (e.g., digital camera 10), excluding the information processing apparatus 100. The portable-recording-medium drive apparatus 105 accommodates a portable recording medium 106 such as an optical disc or CompactFlash®. The portable recording medium 106 serves to assist the storage 103. The storage 103 and the portable recording medium 106 are each an exemplary non-transitory computer-readable storage medium that has a program stored therein.

The configuration depicted in FIG. 4 is an example of the hardware configuration of the information processing apparatus 100. However, the configuration of the information processing apparatus 100 is not limited to this. The information processing apparatus 100 may be a general-purpose apparatus or a dedicated-purpose computer. The information processing apparatus 100 may include electric circuits such as an application specific integrated circuit (ASIC) and a field programmable gate array (FPGA) instead of, or in addition to, a processor for executing a program. These electric circuits may perform the processing described hereinafter.

For example, the acquisition unit, detection unit, recording control unit, rebar measurement unit, registration unit, target detection unit, edge determination unit, and identification information generation unit which will be described hereinafter may each be a circuit such as a processor, an ASIC, or an FPGA. In particular, the acquisition unit, the detection unit, the recording control unit, the rebar measurement unit, the registration unit, the target detection unit, the edge determination unit, and the identification information generation unit maybe, for example, an acquisition circuit, a detection circuit, a recording control circuit, a rebar measurement circuit, a registration circuit, a target detection circuit, an edge determination circuit, and an identification information generation circuit, respectively. When the acquisition circuit, the detection circuit, the recording control circuit, the rebar measurement circuit, the registration circuit, the target detection circuit, the edge determination circuit, and the identification information generation circuit are processor, the processor may be operated as these circuits by reading and executing programs.

The information processing apparatus 100 of the bar-arrangement-inspection assistance system 1 records, in a recording apparatus, rebar measurement information obtained by processing a moving image output from the digital camera 10. The following describes information processing performed by the information processing apparatus 100 so as to record rebar measurement information.

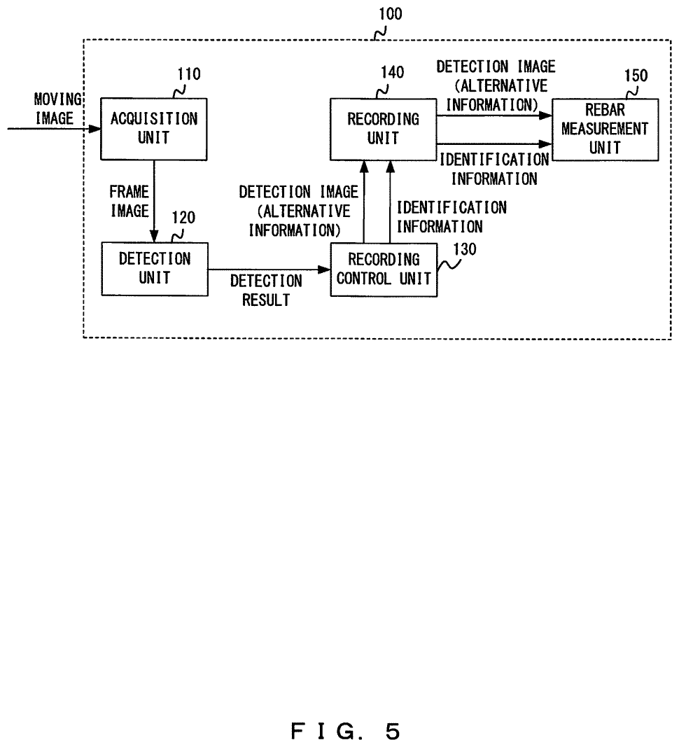

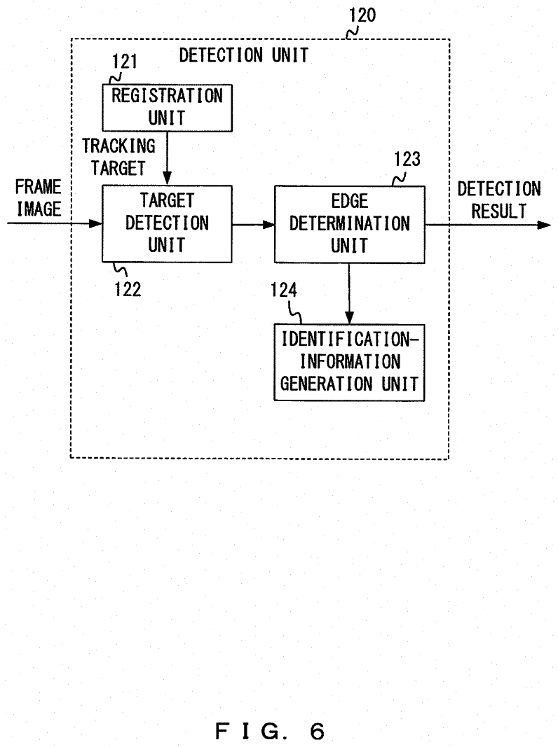

FIG. 5 exemplifies the functional configuration of the information processing apparatus 100. FIG. 6 exemplifies the functional configuration of a detection unit 120. By referring to FIGS. 5 and 6, the following describes the functional configuration of the information processing apparatus 100 that pertains to the information processing.

As depicted in FIG. 5, the information processing apparatus 100 includes an acquisition unit 110, a detection unit 120, a recording control unit 130, a recording unit 140, and a rebar measurement unit 150.

The acquisition unit 110 acquires, in order of image capturing, a plurality of images of an installed rebar group that have been captured while an image capturing region is being moved in a first direction intersecting the rebar group. More specifically, the acquisition unit 110 repeatedly performs a process of extracting a still image from a moving image output from the digital camera 10, thereby acquiring a plurality of still images in order of image capturing. In addition, the acquisition unit 110 outputs the acquired still images to the detection unit 120 in order of image capturing.

The acquisition unit 110 may extract still images from the individual frames of a moving image or may selectively extract still images from arbitrarily selected frames of the moving image. When still images are selectively extracted from arbitrarily selected frames, an extraction timing may be set such that image capturing regions partially overlap each other between one still image to be extracted and another still image to be extracted next to the one image. A still image extracted from a moving image will hereinafter be referred to as a frame image. A still image captured using a still-image capturing function will hereinafter be referred to as a captured image to clarify the difference from a frame image.

The detection unit 120 detects a tracking target from an edge portion of a frame image acquired by the acquisition unit 110 and outputs the detection result to the recording control unit 130. More specifically, the detection unit 120 detects a tracking target from an edge portion in a movement direction opposite from the first direction (hereinafter referred to as a first edge portion).

As depicted in FIG. 6, the detection unit 120 includes a registration unit 121, a target detection unit 122, an edge determination unit 123, and an identification-information generation unit 124.

The registration unit 121 registers a tracking target. The tracking target is, but is not particularly limited to, a rebar included in a rebar group. The registration unit 121 may register any of the rebars included in the rebar group as a tracking target.

The user may specify a tracking target, and the registration unit 121 may register the tracking target in accordance with the user's instruction. The user may designate a frame image, and the registration unit 121 may analyze the designated frame image and register a tracking target on the basis of the result of the analysis. The registration unit 121 may register a tracking target without receiving an instruction from the user. For example, the registration unit 121 may register a tracking target on the basis of a result of analyzing an initial frame image input to the detection unit 120.

The target detection unit 122 detects a tracking target from a frame image acquired by the acquisition unit 110. Specifically, using information on a tracking target detected from one frame image that has been input, the target detection unit 122 detects the tracking target from a frame image input after the one image. In particular, a tracking target is detected by tracking the target by using a tracking algorithm. A frame image from which the target detection unit 122 has detected a tracking target will hereinafter be referred to as a detection image.

The target detection unit 122 may apply an arbitrary tracking algorithm. For example, a template matching method, an updated template matching method, an active search method, a mean-shift method, or a particle filter method, i.e., methods directed to regions, may be used. Alternatively, a tracking-learning-detection (TLD) method, i.e., a method for robustly tracking, by means of a learning function, a tracking target that is a region, may be used. When a tracking target is a rebar, a long and narrow region will be the target. In this case, a feature-point based technique, such as a KLT method, a scale-invariant feature transform (SIFT), or a speeded up robust feature (SURF), i.e., techniques for tracking a feature point, will be useful.

The edge determination unit 123 determines whether a tracking target detected by the target detection unit 122 is located at a position belonging to a first edge portion within a detection image. Upon determining that the position of the tracking target belongs to the first edge portion, the edge determination unit 123 outputs, to the recording control unit 130, a detection result indicating that the tracking target has been detected from the first edge portion.

The first edge portion refers to a portion of a captured image of the target that is to be moved out of the image capturing region in a relatively short time due to the movement of the image capturing region. More specifically, the first edge portion is an edge portion of the image in the movement direction, as described above.

When the edge determination unit 123 determines that the position of the tracking target belongs to the first edge portion within the detection image, the identification-information generation unit 124 generates identification information on the basis of the detection image. The identification information is information for identifying a rebar belonging to the rebar group, i.e., subject Rs, and located within a predetermined range from the tracking target. In particular, the identification information includes, for example, coordinate information indicating a position within the detection image at which the rebar identified by the identification information (hereinafter referred to as an identification-target rebar), posture information of the identification-target rebar, or rotation information of the identification-target rebar.

When a tracking target is a rebar, an identification-target rebar may be a rebar that is a tracking target (hereinafter referred to as a tracking-target rebar). The predetermined range means a range that is not exceedingly distant from a tracking target and is, for example, a range within a distance that is equal to or less than a multiple of the pitch between the tracking target and an installed rebar.

When the detection unit 120 has detected a tracking target from a first edge portion, the recording control unit 130 correlates a detection image or alternative information generated on the basis of the detection image with identification information and records the detection image or alternative information correlated with the identification information in the recording unit 140. The rebar measurement information described above is information obtained as a result of the correlating and recorded in the recording unit 140 by the recording control unit 130 and, in this embodiment, corresponds to either the detection image or alternative information and the identification information that are recorded after being correlated with each other.

Alternative information may be used instead of a detection image in the rebar measurement process. When the number of rebars are counted in the rebar measurement process, the alternative information may be available for counting the number of rebars. For example, the alternative information may be a line drawing that includes lines representing rebars seen in the detection image or may be coordinate information indicating the positions of rebars seen in the detection image. Alternative information generated by the recording control unit 130 on the basis of a detection image may be recorded in the recording unit 140.

The recording unit 140 is the recording apparatus described above and is, for example, the storage 103 depicted in FIG. 4. FIG. 5 depicts an example in which the recording unit 140 is installed in the information recording apparatus 100, but the recording unit 140 may be an external apparatus connected to the information recording apparatus 100. The recording unit 140 maybe a file server or database server that is disposed at a location distant from the information recording apparatus 100 and that can be communicated with over a communication network.

The rebar measurement unit 150 performs the rebar measurement process on the basis of the rebar measurement information recorded in the recording unit 140. For example, the rebar measurement process may be a process of counting the number of rebars, a process of measuring the diameter of rebars, or a process of measuring the pitch between installed rebars. By comparing the measurement results (including the result of counting) with design information, the rebar measurement unit 150 may further perform an inspection process for performing an inspection as to whether rebars have been arranged in conformity to the design information. The rebar measurement unit 150 may be provided at an apparatus different from the information recording apparatus 100.

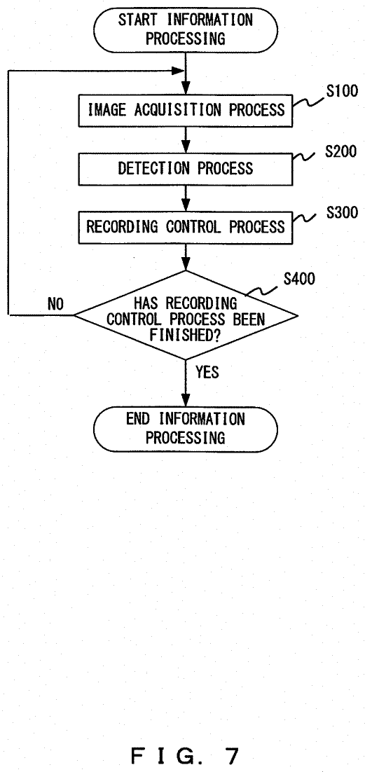

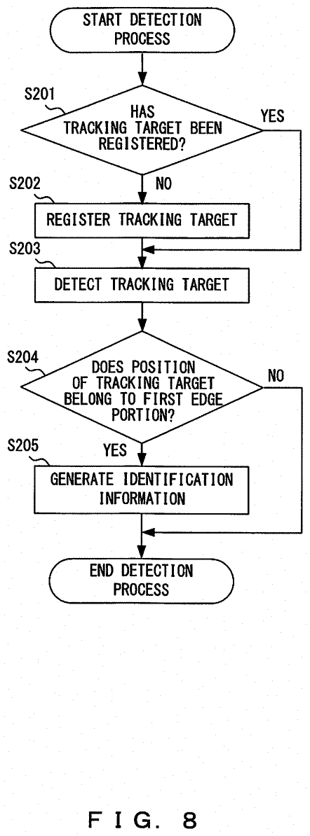

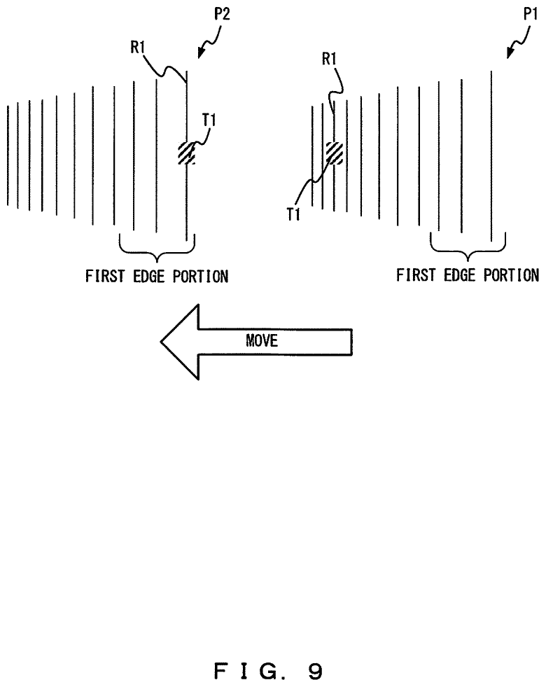

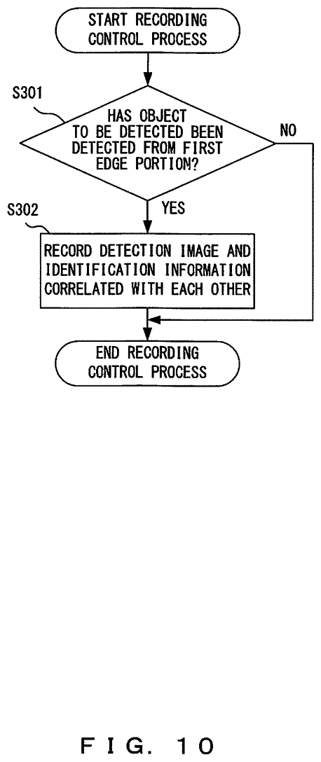

FIG. 7 is a flowchart illustrating an example of information processing. FIG. 8 is a flowchart illustrating an example of a detection process. FIG. 9 is an explanatory diagram for a detection process depicted in FIG. 8. FIG. 10 is a flowchart illustrating an example of a recording control process. The following specifically describes information processing by referring to FIGS. 7-10.

When a moving image of an installed rebar group is input to the information recording apparatus 100, the processor 101 starts the information processing depicted in FIG. 7.

The processor 101 performs an image acquisition process (step S100). The image acquisition process is such that the processor 101 extracts a frame image from the moving image. For example, the extracted frame image may be temporarily stored in the memory 102.

Upon the image acquisition process being finished, the processor 101 performs a detection process (step S200) and a recording control process (step S300). The detection process and the recording control process will be described hereinafter.

Upon the recording control process being finished, the processor 101 performs a finish determination process (step S400). The finish determination process is such that the processor 101 determines whether a preset finish condition has been satisfied. Upon determining that the finish condition has not been satisfied, the processor 101 repeats the processes of steps S100-S400. Upon determining that the finish condition has been satisfied, the processor 101 ends the information processing depicted in FIG. 7.

The finish condition is not particularly limited. The following describes typical examples of the finish condition: Upon detecting a marker indicating an end from a frame image acquired in the image acquisition process, the processor 101 may determine that the finish condition has been satisfied. When the user has input a finish instruction to the information recording apparatus 100, the processor 101 may determine that the finish condition has been satisfied. The processor 101 may detect the posture of the digital camera 10, and when the information recording apparatus 100 has been taking a predetermined posture (e.g., facing downward), the processor 101 may determine that the finish condition has been satisfied.

When the image acquisition process has been finished, the processor 101 of the information recording apparatus 100 starts the detection process depicted in FIG. 8.

The processor 101 determines whether a tracking target has been registered (step S201). When a tracking target has not been registered, the processor 101 registers a tracking target (step S202). The processor 101 detects the tracking target from a frame image (step S203) and determines whether the position of the detected tracking target belongs to a first edge portion of the frame image (step S204). When the position of the tracking target does not belong to the first edge portion, the processor 101 ends the detection process. When the position of the tracking target belongs to the first edge portion, the processor 101 generates identification information on the basis of the frame image (step S205) and then ends the detection process.

The information recording apparatus 100 performs the detection process depicted in FIG. 8 repeatedly for individual frame images. Accordingly, as depicted in FIG. 9, for example, a tracking target T1 may be set over a rebar R1 on the basis of an initially input image P1. An image P2 in which the tracking target T1 is located in a first edge portion is identified from among images input after the image P1 was input, and identification information is generated on the basis of the image P2.

Upon the detection process being finished, the processor 101 of the information recording apparatus 100 starts the recording control process depicted in FIG. 10.

The processor 101 determines whether the tracking target has been detected from the first edge portion in the detection process of step S200 (step S301). When the tracking target has not been detected from the first edge portion, the processor 101 ends the recording control process. When the tracking target has been detected from the first edge portion, the processor 101 correlates the frame image (detection image) or alternative information for substituting for the frame image with the identification information generated in S205 and then records the frame image or alternative image after the correlation in the storage 103 (step S302). Subsequently, the processor 101 ends the recording control process.

The information recording apparatus 100 in accordance with the present embodiment can record rebar measurement information generated from a moving image of a rebar group that has been captured without a subject being marked. Hence, rebar measurement information can be recorded while reducing the burden on the user.

### Second Embodiment

An information recording apparatus in accordance with the present embodiment has a hardware configuration similar to that of the information recording apparatus 100. The functional configuration of the information recording apparatus in accordance with the present embodiment and the functional configuration of the information recording apparatus 100 are different in that the former functional configuration includes a detection unit 220 in place of the detection unit 120 and are otherwise the same.

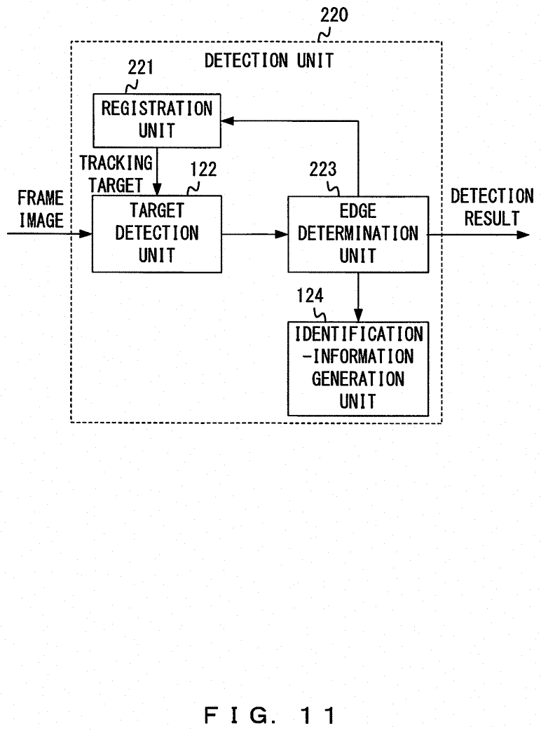

FIG. 11 exemplifies the functional configuration of the detection unit 220. As with the detection unit 120 in accordance with the first embodiment, the detection unit 220 detects a tracking target from a first edge portion of a frame image acquired by the acquisition unit 110 and outputs the detection result to the recording control unit 130.

The detection unit 220 is different from the detection unit 120 in that, as depicted in FIG. 11, the detection unit 220 includes a registration unit 221 in place of the registration unit 121 and an edge determination unit 223 in place of the edge determination unit 123.

As with the registration unit 121, the registration unit 221 registers a tracking target. The registration unit 221 is different from the registration unit 121 in that the registration unit 221 updates a tracking target on the basis of a detection image when the detection unit 220 has detected the tracking target from a first edge portion.

When the detection unit 220 has detected a tracking target from a first edge portion, the registration unit 221 updates the tracking target on the basis of an edge portion in an opposite direction from the movement direction of the detection image (hereinafter referred to as a second edge portion). In particular, for example, the registration unit 221 may update the tracking target by registering any of the rebars located in the second edge portion of the detection image as the tracking target.

The edge determination unit 223 is different from the edge determination unit 123 in that the edge determination unit 223 notifies the registration unit 221 of a timing at which a tracking target is to be updated. In the other respects, the edge determination unit 223 is similar to the edge determination unit 123.

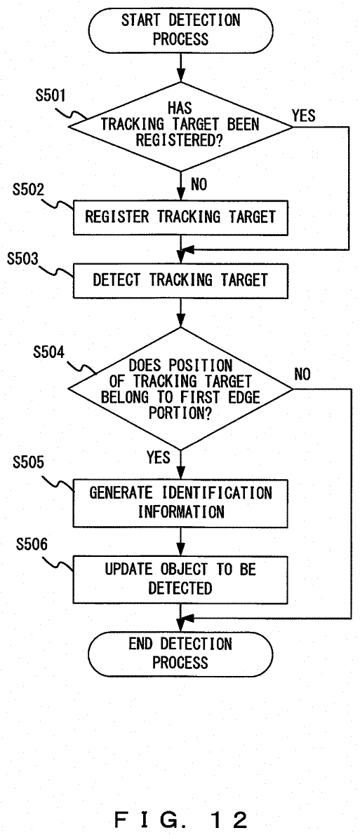

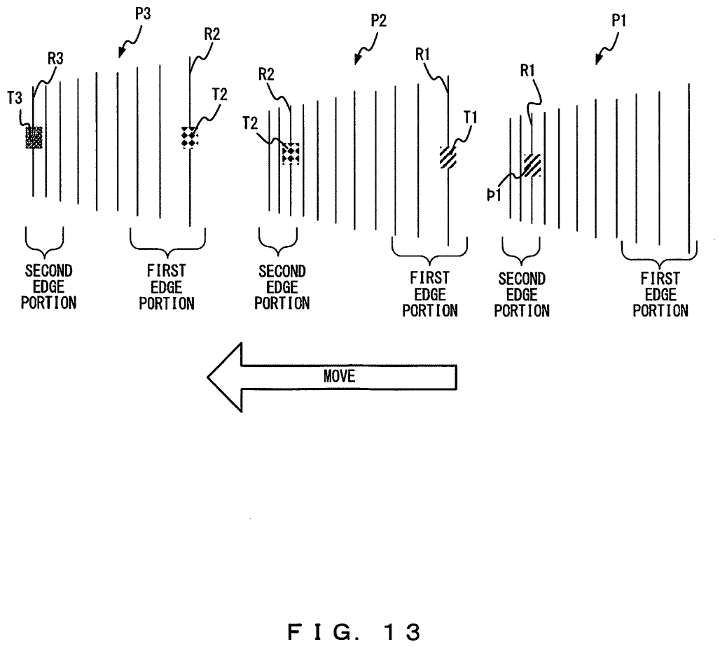

FIG. 12 is a flowchart illustrating an example of a detection process in accordance with the present embodiment. FIG. 13 is an explanatory diagram for the detection process depicted in FIG. 12.

Upon the image acquisition process being finished, the processor 101 of the information recording apparatus in accordance with the present embodiment starts the detection process depicted in FIG. 12. The processes of steps S501-S505 are similar to those of steps S201-S205 in FIG. 8.

When the processor 101 has determined that the position of a detected tracking target belongs to a first edge portion of a frame image (YES in step S504) and has generated identification information on the basis of the frame image (step S505), the processor 101 updates an object to be detected (step S506), and then ends the detection process. Either of the processes of steps S505 and S506 may be performed prior to the other, or these processes may be concurrently performed.

When an image indicating, as depicted in FIG. 13, a tracking target located within a first edge portion (image P2, image P3) has been identified, the information recording apparatus in accordance with the present embodiment generates identification information on the basis of this image and updates the tracking target by registering anew tracking target (tracking target T2, tracking target T3). Accordingly, the tracking process can be continued almost indefinitely by updating the tracking target.

As with the information recording apparatus 100, the information recording apparatus in accordance with the present embodiment can record rebar measurement information generated from a moving image of a rebar group that has been captured without a subject being marked.

The information recording apparatus in accordance with the present embodiment can generate rebar measurement information for individual tracking targets by updating the tracking targets so that more rebar measurement information can be acquired. In addition, when a tracking target has been detected from a first edge portion of a detection image, an object indicated in this detection image is registered as a new object to be detected, so that image capturing regions can partially overlap each other between pieces of rebar measurement information each generated for an individual tracking target. Hence, the rebar measurement information of the entirety of an installed rebar group can be recorded without fail. In particular, an object within a second edge portion may be registered as a new object to be detected, so that the overlap between image capturing regions can be reduced, thereby allowing the rebar measurement information of the entirety of an installed rebar group to be recorded efficiently.

Accordingly, the information recording apparatus in accordance with the present embodiment can also record rebar measurement information while reducing the burden on the user.

### Third Embodiment

An information recording apparatus 300 in accordance with the present embodiment is a recording control apparatus that records, in a recording apparatus, rebar measurement information obtained by processing a moving image. In this respect, the information recording apparatus 300 is the same as the information recording apparatus 100. The information processing apparatus 300 has a hardware configuration similar to that of the information recording apparatus 100 but has a functional configuration different from that of the information recording apparatus 100.

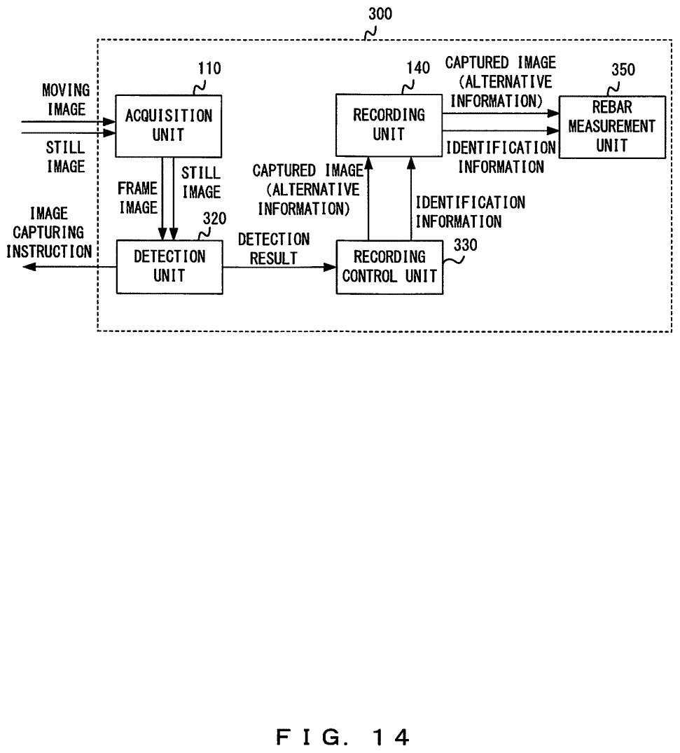

FIG. 14 exemplifies the functional configuration of the information processing apparatus 300. The information processing apparatus 300 is different from the information recording apparatus 100 in that the information processing apparatus 300 includes a detection unit 320 in place of the detection unit 120, a recording control unit 330 in place of the recording control unit 130, and a rebar measurement unit 350 in place of the rebar measurement unit 150.

As with the detection unit 120, when a tracking target has been detected from a first edge portion, the detection unit 320 outputs the detection result to the recording control unit 330. The detection unit 320 is different from the detection unit 120 in that when a tracking target is detected from a first edge portion, the detection unit 320 outputs an image capturing instruction for instructing the digital camera 10 to capture an image. The digital camera 10 captures an image of a rebar group in accordance with the image capturing instruction output from the detection unit 320 and outputs the captured image to the information processing apparatus 300 (acquisition unit 110).

The recording control unit 330 is different from the recording control unit 130 in that when the detection unit 320 has detected a tracking target from a first edge portion, the recording control unit 330 correlates a newly captured image, i.e., a still image of the rebar group newly captured after the detection, or alternative information generated on the basis of the captured image, instead of a detection image or alternative information generated on the basis of the captured image, with identification information and records the captured image or alternative information correlated with the identification information in the recording unit 140.

As with the rebar measurement unit 150, the rebar measurement unit 350 performs the rebar measurement process on the basis of the rebar measurement information obtained as a result of the correlating and recorded in the recording unit 140. The rebar measurement unit 350 is different from the rebar measurement unit 150 in that the rebar measurement information includes identification information and a captured image or alternative information generated on the basis of the captured image.

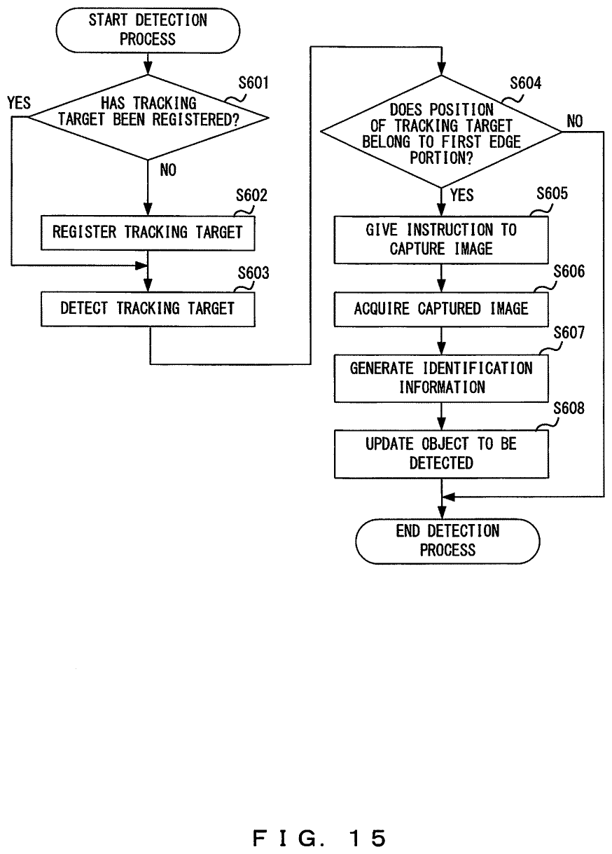

FIG. 15 is a flowchart illustrating an example of the detection process in accordance with the present embodiment. Upon the image acquisition process being finished, the processor 101 of the information recording apparatus in accordance with the present embodiment starts the detection process depicted in FIG. 15. The processes of steps S601-S604 are similar to those of steps S201-S204 in FIG. 8.

Upon determining that the position of a detected tracking target belongs to a first edge portion of a frame image (YES in step S604), the processor 101 instructs the digital camera 10 to capture an image (step S605). Then, a captured image that is a still image of a rebar group newly captured by the digital camera 10 is acquired (step S606). In addition, the processor 101 generates identification information on the basis of the captured image acquired in step S606 (step S607), updates the object to be detected (step S608), and then ends the detection process. Either of the processing series from step S605 to step S607 and the process of step S608 may be performed prior to the other, or these processing series may be concurrently performed.

As with the information recording apparatuses in accordance with the first and second embodiments, the information recording apparatus in accordance with the present embodiment can record rebar measurement information generated from a moving image of a rebar group that has been captured without a subject being marked. In addition, as with the information recording apparatus in accordance with the second embodiment, the information recording apparatus in accordance with the present embodiment can acquire more rebar measurement information to record the rebar measurement information of the entirety of an installed rebar group without fail. Hence, rebar measurement information can be recorded while reducing the burden on the user.

Moreover, when a tracking target has been detected from a first edge portion, the information recording apparatus in accordance with the present embodiment instructs the digital camera 10 to capture an image so that rebar measurement information using the captured image, i.e., a still image, can be recorded. An image captured using a still-image capturing function typically has high resolution in comparison with a frame image (detection image) extracted from a moving image and does not exhibit rolling shutter distortion that could occur in a moving image. Unlike a detection process which can be successful when it is clear at which position within a two-dimensional plane a tracking target is located, the rebar tracking process may be relatively largely adversely affected by distortion. Hence, recording rebar measurement information using a captured image can contribute to improvement of the accuracy in rebar measurement in comparison with recording rebar measurement information using a detection image.

### Fourth Embodiment

An information recording apparatus in accordance with the present embodiment has a hardware configuration similar to that of the information recording apparatus 100. The functional configuration of the information recording apparatus in accordance with the present embodiment and the functional configuration of the information recording apparatus 100 are different in that the former functional configuration includes a detection unit 420 in place of the detection unit 120 and are otherwise the same.

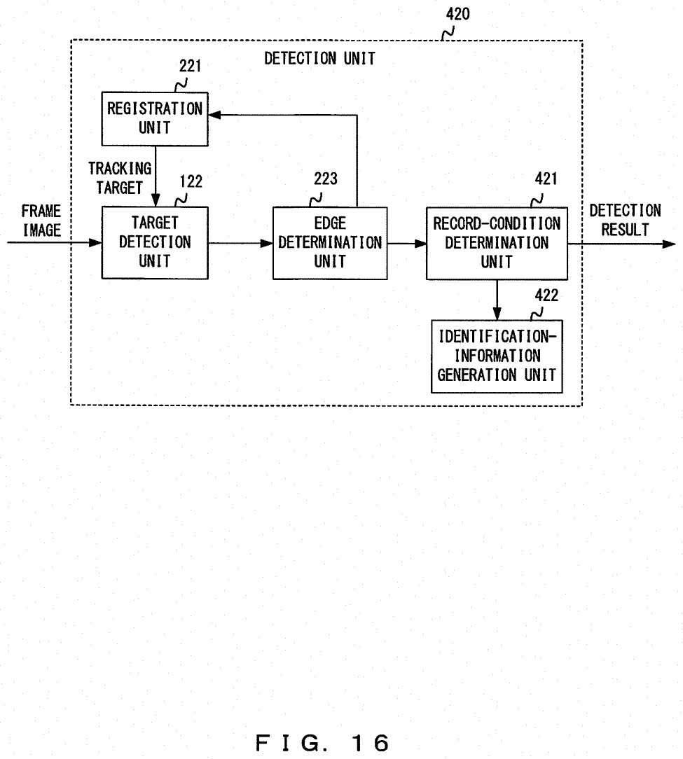

FIG. 16 exemplifies the functional configuration of the detection unit 420. As with the detection unit 120, the detection unit 420 detects a tracking target from a first edge portion of a frame image acquired by the acquisition unit 110.

As depicted in FIG. 15, the detection unit 420 is different from the detection unit 120 in that the detection unit 420 includes a registration unit 221 in place of the registration unit 121, an edge determination unit 223 in place of the edge determination unit 123, and an identification-information generation unit 422 in place of the identification-information generation unit 124 and further includes a record-condition determination unit 421.

The detection unit 420 and the detection unit 220 are different in that the detection unit 420 further includes the record-condition determination unit 421 and includes the identification-information generation unit 422 in place of the identification-information generation unit 124.

The record-condition determination unit 421 determines whether a record condition that is a condition on the length of a rebar indicated in a detection image has been satisfied.

The record condition may be, for example, a condition in which a rebar indicated in a first edge portion of a detection image has a predetermined length or greater. The predetermined length is such a short length that it can be determined that a rebar is not an object to be measured. In general, an installed rebar group includes sequentially arranged rebars that are essentially constant in length. In consideration of this fact, when a rebar that does not satisfy the condition has been detected within a first edge portion, rebars that do not satisfy the condition are estimated to be arranged next to the detected rebar (i.e., arranged in the first direction from the first edge portion). Accordingly, defining a condition on the length of a rebar indicated in the first edge portion as the record condition allows unnecessary information to be prevented from being recorded as rebar measurement information.

The record condition may be, for example, a condition in which at least either a rebar indicated in a first edge portion of a detection image or a rebar indicated in a second edge portion of the detection image has the predetermined length or greater. An installed rebar group rarely includes a rebar that is shorter than the other rebars of this group. Defining conditions on both the length of a rebar indicated in the first edge portion and the length of a rebar indicated in the second edge portion as record conditions allows an incorrect determination that could occur in such a rare case to be prevented from being made.

The record condition may be, for example, a condition in which the percentage of rebars that have the predetermined length or greater among the rebars located between a rebar that is a tracking target before update and a rebar that is a tracking target after update is equal to or higher than a predetermined percentage. Setting such a record condition allows an incorrect determination that could occur in a case such as the rare case described above to be more reliably prevented from being made.

Upon determining that the record-condition determination unit 421 satisfies the record condition, the identification-information generation unit 422 generates identification information.

The information recording apparatus in accordance with the present embodiment is such that when the detection unit 420 has detected a tracking target from a first edge portion and the record-condition determination unit 421 has determined that the record condition has been satisfied, the recording control unit 130 correlates the detection image or alternative information with identification information and records this detection image or alternative information correlated with identification information in the recording apparatus.

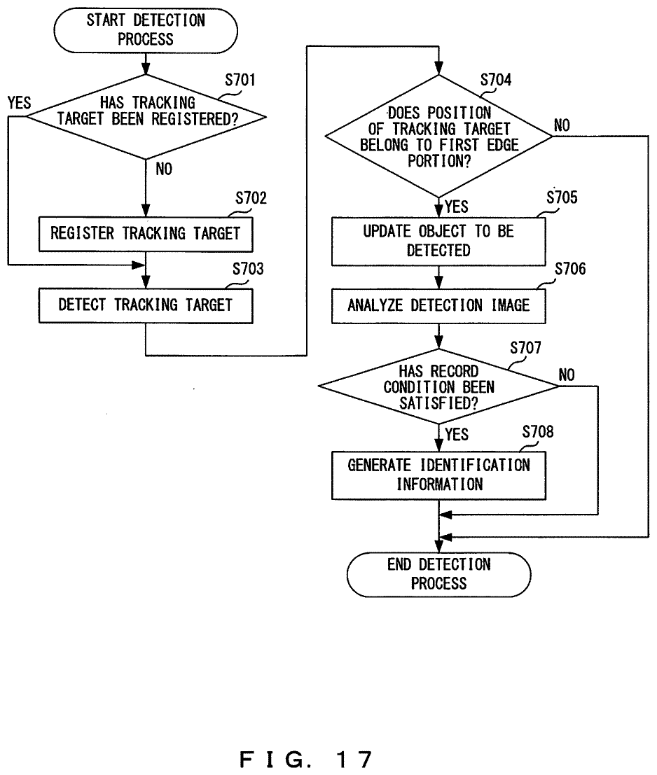

FIG. 17 is a flowchart illustrating an example of the detection process in accordance with the present embodiment. Upon the image acquisition process being finished, the processor 101 of the information recording apparatus in accordance with the present embodiment starts the detection process depicted in FIG. 17. The processes of steps S701-S704 are similar to those of steps S201-S204 in FIG. 8.

Upon determining that the position of a detected tracking target belongs to a first edge portion of a frame image (YES in step S704), the processor 101 updates the object to be detected (step S705), analyzes the frame image (detection image) (step S706), and determines whether the record condition has been satisfied (step S707). When the record condition has not been satisfied, the processor 101 ends the detection process. When the record condition has been satisfied, the processor 101 generates identification information on the basis of the detection image (step S708) and then ends the detection process. Either of the process of step S705 and the processing series from step S706 to step S708 maybe performed prior to the other, or these process and processing series may be concurrently performed.

As with the information recording apparatuses in accordance with the first to third embodiments, the information recording apparatus in accordance with the present embodiment can record rebar measurement information generated from a moving image of a rebar group that has been captured without a subject being marked. In addition, as with the information recording apparatus in accordance with the second embodiment, the information recording apparatus in accordance with the present embodiment can acquire more rebar measurement information to record the rebar measurement information of the entirety of an installed rebar group without fail. Hence, rebar measurement information can be recorded while reducing the burden on the user.

Moreover, when the record condition has not been satisfied, the information recording apparatus in accordance with the present embodiment only updates the tracking target without recording rebar measurement information even when the tracking target has been detected from a first edge portion. This allows unnecessary information to be prevented from being recorded as rebar measurement information.

### Fifth Embodiment

An information processing apparatus 500 in accordance with the present embodiment has a hardware configuration similar to that of the information recording apparatus 100 but has a functional configuration different from that of the information recording apparatus 100.

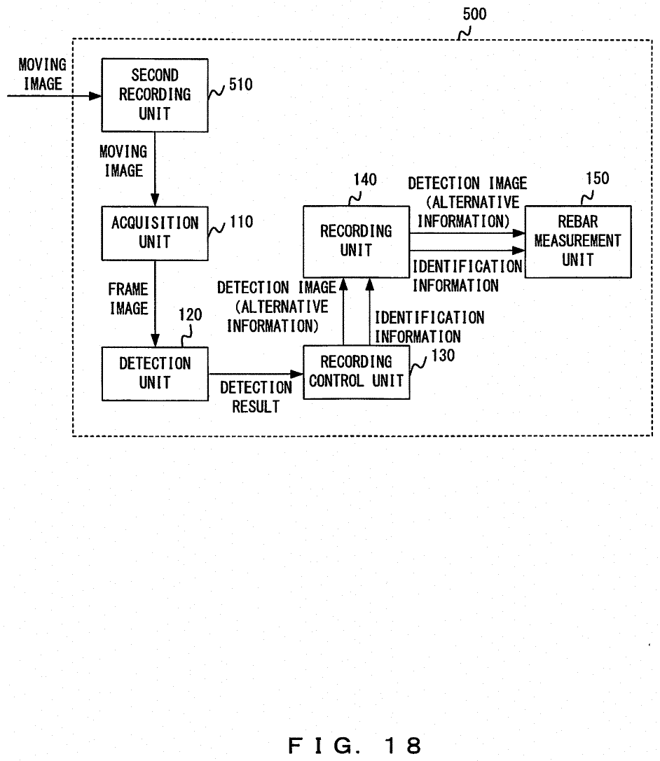

FIG. 18 exemplifies the functional configuration of the information processing apparatus 500. The information processing apparatus 500 is different from the information recording apparatus 100 in that the information processing apparatus 500 includes a second recording unit 510 that records moving images. Although FIG. 18 illustrates that the second recording unit 510 and the recording unit 140 are different functional components, these units may be a single hardware component (e.g., storage 103).

For example, the user may copy, by means of a portable recording medium, a moving image of a rebar group that has been captured at a certain site by using the digital camera 10 to the second recording unit 510 of the information processing apparatus 500 which is installed at a different location from this certain site, such as an office. Hence, the information processing apparatus 500 can read, as appropriate, the moving image from the second recording unit 510 and thus can be operated in the same manner as the information recording apparatus 100.

Accordingly, the information processing apparatus 500 in accordance with the present embodiment can provide advantageous effects similar to those achieved by the information recording apparatus 100. For example, the information processing apparatus 500 and the digital camera 10 maybe used at the same site. Also in this case, a moving image may be recorded in the second recording unit 510, thereby achieving the advantage that the information processing of recording rebar measurement information can be performed without limitations being imposed due to the timing of capturing the moving image.

### Sixth Embodiment

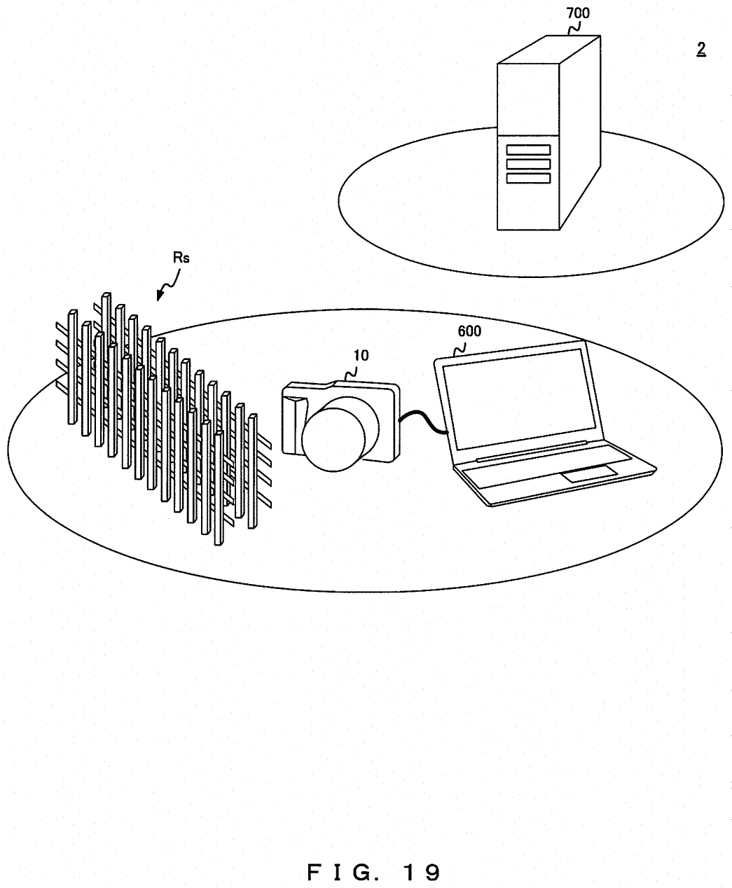

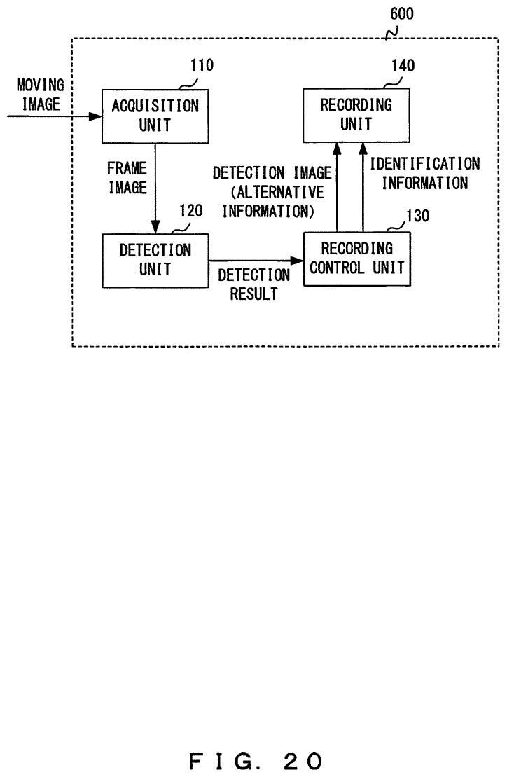

FIG. 19 exemplifies the configuration of a bar-arrangement-inspection assistance system 2 in accordance with the present embodiment. FIG. 20 exemplifies the functional configuration of an information processing apparatus 600 included in the bar-arrangement-inspection assistance system 2.

As depicted in FIG. 19, the bar-arrangement-inspection assistance system 2 includes a digital camera 10, an information processing apparatus 600, and a rebar inspection apparatus 700. Both the information processing apparatus 600 and the rebar inspection apparatus 700 are, for example, standard computers. The digital camera 10 and the information processing apparatus 600 are used in a location (i.e., site) where a subject Rs is present, while the rebar inspection apparatus 700 is installed in a location different from the location where the subject Rs is present (e.g., installed in an office or a data center).

As depicted in FIG. 20, the information processing apparatus 600 is different from the information recording apparatus 100 in accordance with the first embodiment in that the information processing apparatus 600 does not include the rebar measurement unit 150. In the other respects, the information processing apparatus 600 is similar to the information recording apparatus 100. Meanwhile, the rebar inspection apparatus 700 has a function that corresponds to the rebar measurement unit 150.

The bar-arrangement-inspection assistance system 2 in accordance with the present embodiment is such that the processes up to the above-described information processing of recording rebar measurement information are performed on site using the information processing apparatus 600, and the rebar measurement process is performed by the rebar inspection apparatus 700.

The bar-arrangement-inspection assistance system 2 in accordance with the present embodiment can provide advantageous effects similar to those achieved by the bar-arrangement-inspection assistance system 1. The bar-arrangement-inspection assistance system 2 can perform the rebar measurement process, i.e., a process that imposes a relatively high load on a computer, by using an apparatus different from the information processing apparatus 600, so that the information processing apparatus 600 can be configured with a relatively-low-spec computer.

### Seventh Embodiment

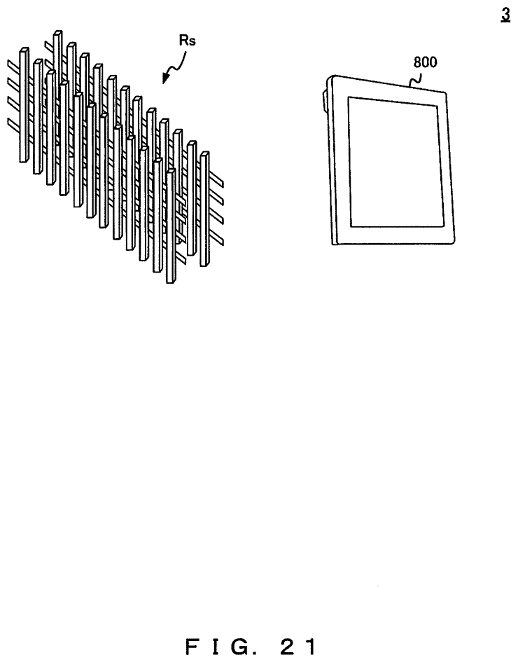

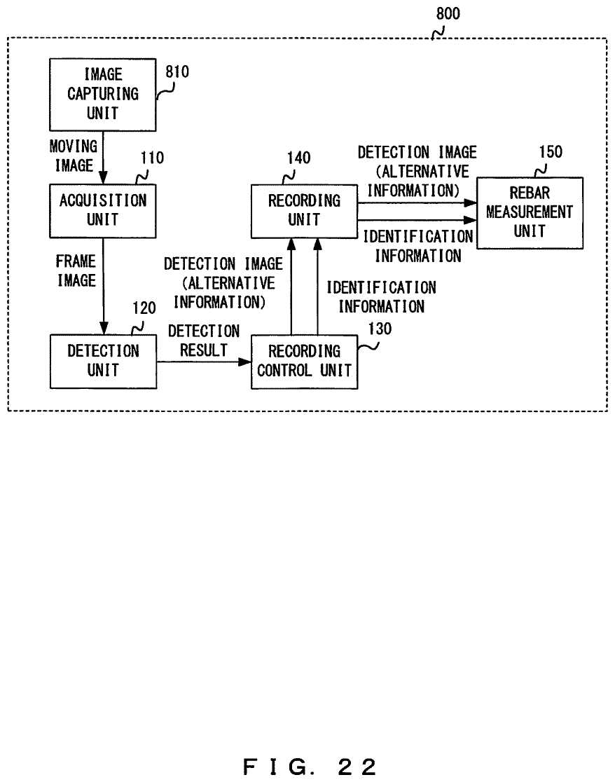

FIG. 21 exemplifies the configuration of a bar-arrangement-inspection assistance system 3 in accordance with the present embodiment. FIG. 22 exemplifies the functional configuration of an information processing apparatus 800 included in the bar-arrangement-inspection assistance system 3.

As depicted in FIG. 21, the bar-arrangement-inspection assistance system 3 includes the information processing apparatus 800. The information processing apparatus 800 is, for example, a tablet computer and has the functions of both the digital camera 10 and the information recording apparatus 100 of the bar-arrangement-inspection assistance system 1 in accordance with the first embodiment.

The information processing apparatus 800 is different from the information recording apparatus 100 in that the information processing apparatus 800 includes an image capturing unit 810, as depicted in FIG. 22. For example, the image capturing unit 810 may be an image capturing apparatus such as a camera. In the other respects, the information processing apparatus 800 is similar to the information recording apparatus 100.

The bar-arrangement-inspection assistance system 3 in accordance with the present embodiment can provide advantageous effects similar to those achieved by the bar-arrangement-inspection assistance system 1. The bar-arrangement-inspection assistance system 3 has a digital camera incorporated into the information processing apparatus 800 and is thus superior in portability to the bar-arrangement-inspection assistance system 1. Hence, the bar-arrangement-inspection assistance system 3 is preferable for use in an outdoor environment such as a construction site.

Embodiments have been described by referring to examples in which a tracking target is detected on the basis of a frame image extracted from a moving image. However, an image to be used for tracking is not limited to a moving image. For example, a plurality of still images (captured images) continuously captured while an image capturing region is being moved may be used.

Embodiments have been described by referring to examples in which rebar measurement information is recorded when a tracking target has been detected from a first edge portion. However, rebar measurement information may be recorded when, for example, tracking starts (i.e., when a tracking target is initially registered) or tracking ends (i.e., when the finish determination has been satisfied). In this case, coordinate information of the start and end points of a rebar to be measured will desirably be recorded as identification information. The start and endpoints of a rebar to be measured may be specified by markers provided on a subject or may be specified through user input. When coordinate information of the start and endpoints of a rebar to be measured is not recorded, the start and endpoints maybe determined from an image during the rebar measurement process.

Examples of the identification information in the embodiments described above include coordinate information indicating a position within a detection image of an identification-target rebar, posture information of the identification-target rebar, and rotation information of the identification-target rebar. However, the identification information may further include other types of information for identifying the identification-target rebar. For example, the identification information may include the movement velocity or movement amount of an image capturing region or a partial image of the vicinity of a tracking target.

Embodiments have been described by referring to examples in which a single tracking target is tracked, but a plurality of tracking targets may be set on the same rebar. Making such a setting allows a tracking-target rebar to be tracked more reliably.

Embodiments have been described by referring to examples in which a rebar arranged in a direction intersecting the first direction is registered as a tracking target. However, it will be desirable to not set a tracking target within a region that is located on a rebar arranged in a direction intersecting the first direction and overlaps a rebar arranged in the first direction. This is because setting a tracking target within such a region would make the tracking difficult to perform.

Embodiments have been described by referring to examples in which rebar measurement information is recorded when a tracking target has been detected from a first edge portion. However, the recording of rebar measurement information may be triggered by a different factor. For example, rebar measurement information may be recorded every time the image capturing region is moved by a distance that corresponds to a predetermined number of rebars to be measured.

Embodiments have been described by referring to examples in which an image or alternative information correlated with identification information is recorded. However, when displaying a recorded image, the recorded image may be displayed with an imaginary marker added to a rebar identified by identification information. Accordingly, image capturing regions recorded in an overlapped manner can be easily visually identified.

The bar-arrangement-inspection assistance system in accordance with the described embodiments may include a stereo camera, and the information processing apparatus included in the bar-arrangement-inspection assistance system may perform information processing using an image acquired by the stereo camera. For example, one of moving images acquired by the stereo camera may be subjected to the image acquisition process and the detection process, and two images having a parallax therebetween may be captured when a tracking target has been detected from a first edge portion. This method is preferable especially when a rebar measurement process that requires depth information is performed. Both moving images acquired by the stereo camera may be subjected to the image acquisition process and the detection process. This allows a tracking target to be tracked more reliably.

The described embodiments allow the burden on the operator in performing a bar arrangement inspection to be reduced even when rebars are disposed over a wide range.

The embodiments described above indicate specific examples to facilitate understanding of the invention, and the present invention is not limited to those embodiments. Various modifications or changes can be made to the information processing apparatus, the rebar counting apparatus, the method, and the program without departing from the invention recited in the claims.

What is claimed is:

1. An information processing apparatus comprising:
a memory; and
a processor connected to the memory, wherein the processor
acquires, in order of image capturing, a plurality of images of an installed rebar group that have been captured while an image capturing region is being moved in a direction intersecting the rebar group,
detects a tracking target from a first edge portion that is an edge portion of an image acquired by the acquisition and is also an edge portion in a movement direction in which the rebar group is moved within the image, and
correlates, when the processor has detected the tracking target from the first edge portion, either of a detection image that is an image of the detected tracking target or a captured image that is an image of the rebar group that has been newly captured after the detection of the tracking target or alternative information generated on the basis of the detection image or the captured image with identification information for identifying a rebar belonging to the rebar group and located within a predetermined range from the tracking target, and records the detection image, the captured image, or alternative information correlated with the identification information in a recording apparatus.

2. The information processing apparatus of claim 1, wherein
the processor detects the tracking target from the images acquired by the acquisition, and determines whether the detected tracking target is located at a position belonging to the first edge portion within the detection image.

3. The information processing apparatus of claim 1, wherein
the processor registers the tracking target, and updates the tracking target on the basis of the detection image when the processor has detected the tracking target from the first edge portion.

4. The information processing apparatus of claim 1, wherein
the processor registers the tracking target, and updates, when the processor has detected the tracking target from the first edge portion, the tracking target on the basis of a second edge portion that is an edge portion in an opposite direction from the movement direction of the detection image.

5. The information processing apparatus of claim 3, wherein
the processor registers any of the rebars included in the rebar group as a tracking target.

6. The information processing apparatus of claim 1, wherein
the processor
determines whether a record condition that is a condition on a length of a rebar indicated in the detection image has been satisfied, and
correlates, when the processor has detected the tracking target from the first edge portion and has determined that the record condition has been satisfied, either of the detection image or the captured image or the alternative information with the identification information and records the detection image, the captured image, or alternative information correlated with the identification information in the recording apparatus.

7. The information processing apparatus of claim 6, wherein
the record condition is a condition in which a rebar indicated in the first edge portion of the detection image has a predetermined length or greater.

8. The information processing apparatus of claim 6, wherein
the record condition is a condition in which at least one of a rebar indicated in the first edge portion of the detection image and a rebar indicated in the second edge portion of the detection image has a predetermined length or greater.

9. An information processing method comprising:
acquiring, in order of image capturing, a plurality of images of an installed rebar group that have been captured while an image capturing region is being moved in a direction intersecting the rebar group;
detecting a tracking target from a first edge portion that is an edge portion of an acquired image and is also an edge portion in a movement direction in which the rebar group is moved within the image; and
when the tracking target has been detected from the first edge portion, correlating either of a detection image that is an image of the detected tracking target or a captured image that is an image of the rebar group that has been newly captured after the detection of the tracking target or alternative information generated on the basis of the detection image or the captured image with identification information for identifying a rebar belonging to the rebar group and located within a predetermined range from the tracking target, and recording the detection image, the captured image, or alternative information correlated with the identification information in a recording apparatus.

10. A non-transitory recording medium having stored therein a program for causing a computer to perform a process comprising:
acquiring, in order of image capturing, a plurality of images of an installed rebar group that have been captured while an image capturing region is being moved in a direction intersecting the rebar group;
detecting a tracking target from a first edge portion that is an edge portion of an acquired image and is also an edge portion in a movement direction in which the rebar group is moved within the image; and
when the tracking target has been detected from the first edge portion, correlating either of a detection image that is an image of the detected tracking target or a captured image that is an image of the rebar group that has been newly captured after the detection of the tracking target or alternative information generated on the basis of the detection image or the captured image with identification information for identifying a rebar belonging to the rebar group and located within a predetermined range from the tracking target, and recording the detection image, the captured image, or alternative information correlated with the identification information in a recording apparatus.
